(19) United States
(12) Patent Application Publication
(10) Pub. No.: US 2009/0148550 A1
(43) Pub. Date: Jun. 11, 2009

(54) Hot-Runner Nozzle Assembly Configured to Reduce Stress Between Copper Body and Reinforcement Body

(75) Inventor: Sohail MOHAMMED, Colchester, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/951,361

(22) Filed: Dec. 6, 2007

(51) Int. Cl. B29C 45/20

(52) U.S. Cl. 425/549

(57) ABSTRACT

Disclosed is a hot-runner nozzle assembly, including: (i) a copper body having a copper alloy, and (ii) a reinforcement body being coupled with the copper body, the reinforcement body having a reinforcement alloy being configured to minimize thermal-expansion stress being induced between the copper alloy and the reinforcement alloy.

### TECHNICAL FIELD

The present invention generally relates to injection-molding systems, and more specifically, the present invention relates to hot-runner systems of injection-molding systems, and to hot-runner nozzle assemblies of hot-runner systems.

### BACKGROUND

Known hot-runner nozzle assemblies include nozzle tips that have a copper alloy. Since the copper alloy wears out, these nozzle tips must be replaced from time to time, either: (i) preferably during preventive maintenance routines, or (ii) inadvertently during molding operations, in which replacement costs and repair costs tend to be even higher because the molding system remains idling while inadvertently failed nozzle tips are replaced, and this arrangement leads to lost efficiencies.

U.S. Pat. No. 6,164,954 (Inventor: MORTAZAVI et al.: Published: Dec. 26, 2000) discloses an injection nozzle apparatus that includes an inner body portion and an outer body portion. The inner body portion includes a melt channel. The outer body portion is made of a pressure resistant material. The ratio between the inner diameter of the outer body portion and the outer diameter of the inner body portion is selected so that a pre-load or a load is generated when assembling the outer body portion over the inner body portion. Preferably, the assembly of the two bodies is removably fastened to an injection nozzle body. Preferably the inner body portion includes a material having wear resistant characteristics to withstand abrasive or corrosive molten materials. The apparatus is particularly useful in molding machines and hot runner nozzles for high-pressure molding of materials at normal or elevated process temperatures.

U.S. Pat. No. 6,609,902 (Inventor: BLAIS et al.: Published: Aug. 26, 2003) discloses a nozzle for an injection molding runner system that includes: (i) a nozzle housing having a melt channel, (ii) a nozzle tip having a tip channel and at least one outlet aperture in communication with the tip channel, and (iii) a tip retainer that retains the nozzle tip against the nozzle housing such that the tip channel communicates with the melt channel. The tip retainer is significantly more thermally conductive than the nozzle tip. A nozzle seal: (i) is significantly less thermally conductive than the tip retainer, (ii) may be fused with the tip retainer, and (iii) may be annularly spaced from the nozzle tip.

U.S. Pat. No. 7,108,503 (Inventor: OLARU: Published: Sep. 19, 2006) discloses a nozzle for an injection molding apparatus. The injection molding apparatus has a mold component that defines a mold cavity and a gate leading into the mold cavity. The nozzle includes a nozzle body, a heater, a tip, a tip surrounding piece and a mold component contacting piece. The nozzle body defines a passage that is adapted to receive melt from a melt source. The heater is thermally connected to the nozzle body for heating melt in the nozzle body. The tip defines a tip melt passage that is located downstream from the melt passage. The tip is adapted to be upstream from the gate. The tip surrounding piece is removably connected with respect to said nozzle body. The mold component contacting piece is connected with respect to the nozzle body. The material of the mold component contacting piece has a thermal conductivity that is less than at least one of: (i) the thermal conductivity of the material of the tip, and (ii) the thermal conductivity of the material of the tip surrounding piece.

### SUMMARY

The inventor believes that in known nozzle tip assemblies, a highly heat conductive tip, which carries heat and melt to a mold gate, is retained by a surrounding piece that needs to possess a low-thermal conductivity to prevent heat loss upon contact (to seal) with the mold steel of the mold gate. Conventionally, (i) copper alloys with high thermal conductivity are used in nozzle tips, and (ii) tool steels (such as: an alloy of PH13-8, an alloy of H13, and/or titanium/nickel alloys, etc) are used in an insulating body that have relatively lower thermal conductivity. The inventor believes that the disadvantage with the prior art is that the steel alloys used in prior art nozzle assemblies possess different thermal expansion properties when compared to a copper alloy. The problem is evident when the nozzle tip is heated for molding and the two materials expand at varying rates of expansion, which leads to exertion of undesirable stress in the mating planes (between the materials) when the two pieces are joined by methods including (such as): welding, brazing, threading and/or interference fitting, etc.

According to a first aspect of the present invention, there is provided a hot-runner nozzle assembly, including: (i) a copper body having a copper alloy, and (ii) a reinforcement body being coupled with the copper body, the reinforcement body having a reinforcement alloy being configured to minimize thermal-expansion stress being induced between the copper alloy and the reinforcement alloy.

The technical effect of the reinforcement alloy is that the thermal properties of the reinforcement alloy (preferably, along with other attributes such as: high-temperature strength, corrosion resistance, oxidation resistance and/or wear resistance) make it suited for use in hot-runner nozzle assemblies. The reinforcement alloy may reduce significant amount of stresses in the hot-runner nozzle assembly, so that this arrangement may: (i) improve part life, (ii) prevent plastic leakage from critical seals, and/or (ii) increase customer run time. The aspects of the present invention permit improved service life of copper alloys in a hot-runner system.

### DETAILED DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

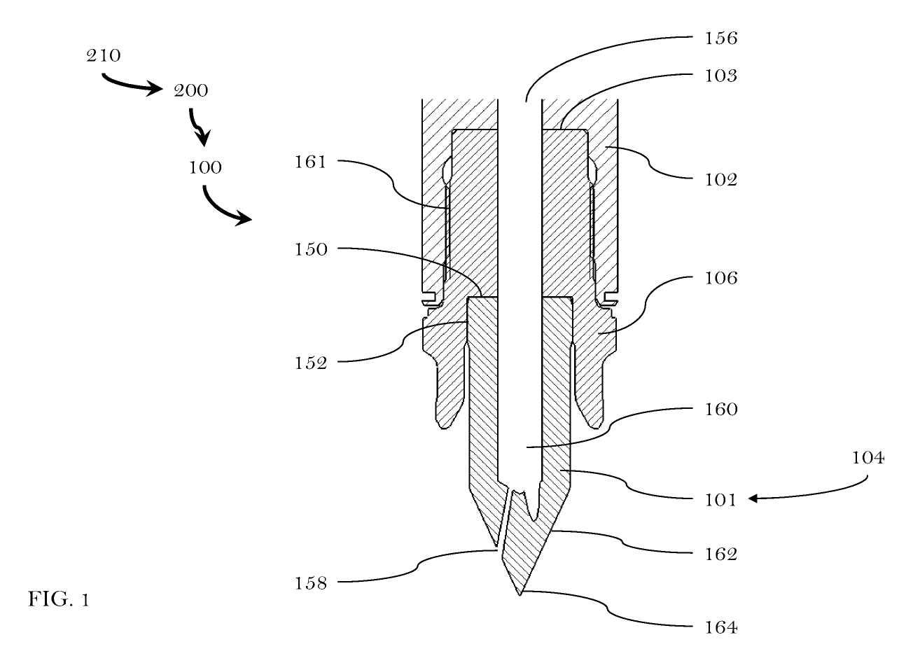

FIG. 1 depicts a cross-sectional view of a hot-runner nozzle assembly 100 (hereafter referred to as the “assembly 100”) according to a first non-limiting embodiment;

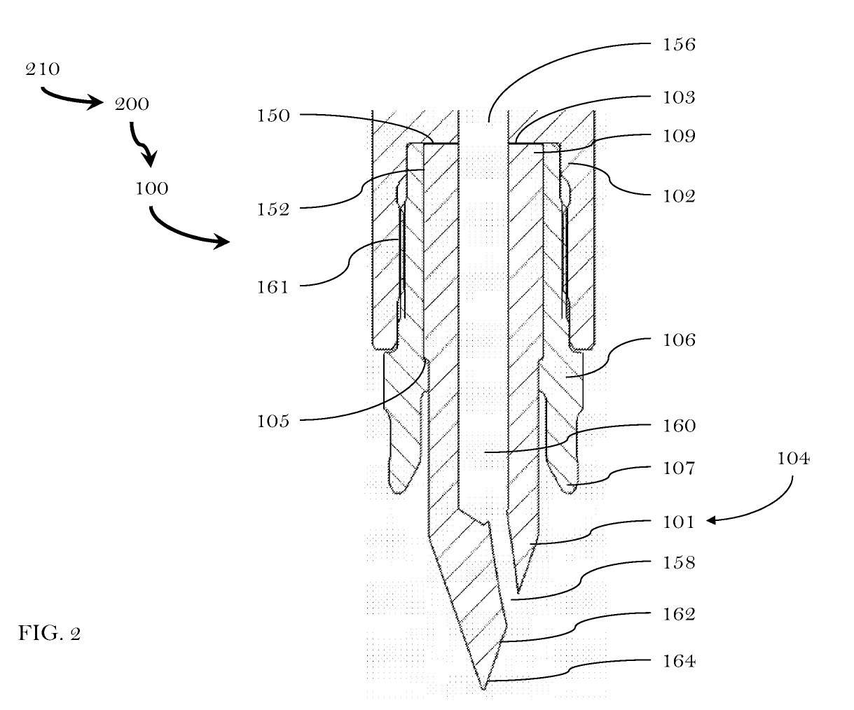

FIG. 2 depicts a cross-sectional view of the assembly 100 according to a second non-limiting embodiment; and

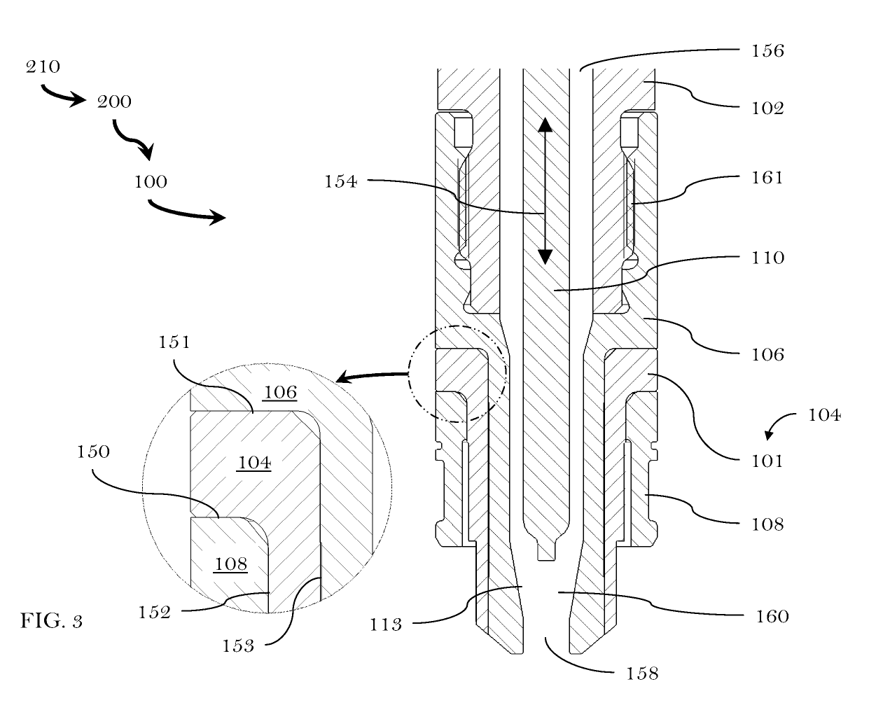

FIG. 3 depicts a cross-sectional view of the assembly 100 according to a third non-limiting embodiment.

### DETAILED DESCRIPTION OF THE NON-LIMITING EMBODIMENTS

FIG. 1 depicts the cross-sectional view of the assembly 100. An injection-molding system 210 (not depicted, but known) includes a hot runner 200 (not depicted, but known), and the hot runner 200 includes the assembly 100. It will be appreciated that the injection-molding system 210, the hot runner 200 and the assembly 100 may be sold together or separately. The assembly 100 includes: (i) a housing body 102, (ii) a copper body 104, and (iii) a reinforcement body 106. The reinforcement body 106 is used to reinforce the copper body 104. The housing body 102 is threadably attached with the reinforcement body 106. Threads 161 are used to threadably couple the housing body 102 with the reinforcement body 106. The housing body 102 includes a housing recess that is defined at an end of the housing body 102. The housing recess is recessed axially into the housing body 102. The housing recess receives the reinforcement body 106. Once installed in the housing recess of the housing body 102, the reinforcement body 106 abuts an end stop 103 of the housing body 102. The reinforcement body 106 defines a reinforcement recess, which is configured to receive the copper body 104. The reinforcement recess is recessed axially into the reinforcement body 106. Once the copper body 104 is received in the reinforcement recess of the reinforcement body 106, the copper body 104 is offset from the end stop 103 of the housing body 102. By way of example, the copper body 104 and the reinforcement body 106 may be coupled (or held together) together by any one of: encapsulation, butt joining, welding, brazing, threading or interference fitting, etc. The copper body 104 includes, by way of example, a nozzle-tip body 101. A melt channel 160 is defined through the combination of the housing body 102, the copper body 104 and the reinforcement body 106 once they are so assembled. The housing body 102 includes an entrance 156, and the copper body 104 includes an exit 158 that is offset from the entrance 156, so that the melt channel 160 extends from the entrance 156 to the exit 158. The copper body 104 includes a tapered shoulder 162 that extends axially to a nozzle tip 164 that defines an apex of the copper body 104. A radial mating plane 150 joins the copper body 104 with the reinforcement body 106. An axial mating plane 152 joins the copper body 104 with the reinforcement body 106. A radial mating plane 150 extends between the end stop 103 of the housing body 102 and the end of the reinforcement body 106. Heat may flow from heaters (not depicted, but known) that are coupled with the housing body 102 to reinforcement body 106, then through the reinforcement body 106 and then toward the copper body 104.

The copper body 104 has or includes, preferably, a copper alloy, such as (for example) a beryllium copper alloy (also known as “BeCu3”). The reinforcement body 106 has or includes a reinforcement alloy. The reinforcement alloy is configured so that any stress induced by thermal expansion of the copper alloy of the copper body 104 and of the reinforcement alloy is minimized. For example, the reinforcement alloy includes any one of: (i) an alloy A-286, (ii) an alloy of Inconel 718 (also known as IN718), and/or (iii) a high-strength 300 Series stainless steel alloy. The alloy of A-286 stainless steel possesses: (i) high thermal expansion property that is comparable to a copper alloy, and (ii) a low-thermal conductivity property that is comparable to an alloy of PH13-8. The alloy A-286 may be purchased from High Temp Metals, Incorporated (www.hightempmetals.com). The high-strength 300 Series stainless steel alloy may be purchased from Special Metals Corporation (www.specialmetals.com). The Inconel 718 may be purchased from Special Metals Corporation (www.specialmetals.com).

A thermal expansion coefficient of the reinforcement alloy is substantially similar to the thermal expansion coefficient of the copper alloy. The copper alloy and the reinforcement alloy may have a range of thermal expansion from between about 14×10⁻⁶ m/m/° C. (meter per meter per degree Centigrade) and about 18×10⁻⁶ m/m/° C. (meter per meter per degree Centigrade). A maximum difference in thermal expansion between the copper alloy and the reinforcement alloy may be about 4×10⁻⁶ m/m/° C. It will be appreciated that differences that are higher than 4×10⁻⁶ m/m/° C. may cause the mating planes 150 and 152 to experience higher mechanical stresses due to the thermal expansion between the reinforcement body 106 and the copper body 104, and thus separation between the reinforcement body 106 and the copper body 104 may be inadvertently and disadvantageously accelerated.

FIG. 2 depicts a cross-sectional view of the assembly 100. The reinforcement body 106 defines a passageway that extends through the reinforcement body 106 from one end to the other end of the reinforcement body 106, so that the reinforcement body 106 resembles a tube. The reinforcement body 106 includes a retention step 105 that is in the passageway of the reinforcement body 106. The passageway of the reinforcement body 106 is configured to receive the copper body 104, so that the copper body 104 may then abut the retention step 105. Once the copper body 104 is fully received in the passageway of the reinforcement body 106, the reinforcement body 106 may then be attached or coupled to the housing body 102. The housing body 102 includes a housing recess defined at an end of the housing body 102, and the housing recess receives the reinforcement body 106 (while the reinforcement body 106 receives the copper body 104). The reinforcement body 106 threadably engages the recess defined by the housing body 102 (by the threads 161). Once installed in the recess of the housing body 102: (i) the reinforcement body 106 abuts the end stop 103 of the housing body 102, and (ii) since the copper body 104 is fully received in the passageway of the reinforcement body 106, the copper body 104 also abuts the end stop 103 of the housing body 102. In this manner, the radial mating plane 150 extends between: (i) the end stop 103 of the housing body 102 and the end of the copper body 104, and (ii) the end stop 103 and the end of the reinforcement body 106. In this manner, heat may flow from heaters (not depicted, but known) that are coupled with the housing body 102 to the copper body 104 through the end stop 103 of the housing body 102, and then to the end of the copper body 104.

When heated, both the copper body 104 and the reinforcement body 106: (i) undergo substantial thermal expansion, and (ii) grow toward the direction of the nozzle tip 164. The segments of the reinforcement body 106 and the copper body 104 between the end stop 103 and the retention step 105 will expand according to the expansion property of the reinforcement alloy and the copper alloy associated with the reinforcement body 106 and the copper body 104, respectively. If the reinforcement body 106 expands considerably less than the copper body 104, then high stresses may occur on the copper body 104 near the retention step 105 since the growth of the copper body 104 will tend to be constrained in the axial direction. Selection of alloys where both alloys possess similar thermal expansion coefficients may greatly reduce the stresses caused by a differential in thermal expansion between the reinforcement alloy and the copper alloy.

FIG. 3 depicts a cross-sectional view of the assembly 100. The assembly 100 further includes a second reinforcement body 108, and the copper body 104 is positioned between the second reinforcement body 108 and the reinforcement body 106. The second reinforcement body 108 includes a second reinforcement alloy that is similar to that of the reinforcement alloy of the reinforcement body 106, so that the second reinforcement alloy is configured to minimize thermal-expansion stress that may be induced between the copper alloy and the second reinforcement alloy.

According to a variant, the reinforcement body 106 includes (or is also known as) a “liner”. The reinforcement body 106 is configured to receive a stem 110, and the stem 110 is linearly axially movable along the reinforcement body 106. The reinforcement body 106 is coupled with the housing body 102 (via threads 161). The copper body 104 includes (or is also known as) a “sleeve”. The copper body 104 defines a copper-body bore that is configured to receive the reinforcement body 106. The second reinforcement body 108 includes (or is also known as) a “seal ring”. The second reinforcement body 108 defines a channel that extends through the second reinforcement body 108, and the channel is configured to receive the copper body 104.

The non-limiting embodiments described above reduces unwanted stresses in the mating planes 150, 151, 152 and 153 since the copper alloy and the reinforcement alloy (with comparable thermal expansion coefficients) expand at similar rates of expansion while providing desirable heat management with their differing thermal conductivities (that is, the reinforcement alloy tends to act as a heat insulator while the copper alloy tends to act as a thermal conductor). Additionally the reinforcement alloy has a tendency to resist thermal expansion under high temperature (relative to the copper alloy), while also having (advantageously) lower corrosion and lower oxidation attributes. By way of example: (i) the copper body 104 includes a nozzle-tip body 101, and (ii) the reinforcement body 106 includes an insulator, a liner, and/or a gate seal.

The description of the non-limiting embodiments provides non-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is to be understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention are the subject of dependent claims. Therefore, what is to be protected by way of letters patent are limited only by the scope of the following claims:

What is claimed is:

1. A hot-runner nozzle assembly, comprising:
a copper body having a copper alloy; and
a reinforcement body being coupled with the copper body, the reinforcement body having a reinforcement alloy being configured to minimize thermal-expansion stress being induced between the copper alloy and the reinforcement alloy.

2. The hot-runner nozzle assembly of claim 1, wherein:
the copper body includes a nozzle-tip body.

3. The hot-runner nozzle assembly of claim 1, further comprising:
a second reinforcement body being coupled with the reinforcement body, the second reinforcement body having an alloy being similar to the reinforcement body.

4. The hot-runner nozzle assembly of claim 1, further comprising:
a housing body being coupled with the reinforcement body.

5. The hot-runner nozzle assembly of claim 1, wherein:
a thermal expansion coefficient of the reinforcement alloy is substantially similar to the thermal expansion coefficient of the copper alloy.

6. The hot-runner nozzle assembly of claim 1, wherein:
the copper alloy and the reinforcement alloy have a range of thermal expansion from between about 14×10⁻⁶ and about 18×10⁻⁶ meter per meter per degree Centigrade.

7. The hot-runner nozzle assembly of claim 1, wherein:
a maximum difference in thermal expansion between the copper alloy and the reinforcement alloy is about 4×10⁻⁶ meter per meter per degree Centigrade.

8. The hot-runner nozzle assembly of claim 1, wherein:
the copper alloy includes:
a beryllium copper alloy.

9. The hot-runner nozzle assembly of claim 1, wherein:
the reinforcement alloy includes:
the A-286 alloy.

10. The hot-runner nozzle assembly of claim 1, wherein:
the reinforcement alloy includes:
a high-strength 300 Series stainless steel alloy.

11. The hot-runner nozzle assembly of claim 1, wherein:
the reinforcement alloy includes:
an Inconel 718 alloy.

12. The hot-runner nozzle assembly of claim 1, further comprising:
a radial mating plane joining the copper body with the reinforcement body.

13. The hot-runner nozzle assembly of claim 1, further comprising:
an axial mating plane joining the copper body with the reinforcement body.

14. The hot-runner nozzle assembly of claim 1, wherein:
the copper body and the reinforcement body are coupled together by any one of: (i) encapsulation, (ii) butt joining, (iii) welding, (iii) brazing, (iv) threaded connection, and (iv) interference fitting.

15. The hot-runner nozzle assembly of claim 1, further comprising:
a second reinforcement body, and the copper body is positioned between the second reinforcement body and the reinforcement body.

16. The hot-runner nozzle assembly of claim 1, further comprising:
a housing body being coupled with the reinforcement body, and
the copper body includes a nozzle-tip body.

17. A hot-runner nozzle assembly, comprising:
a copper body having a copper alloy; and
a reinforcement body being coupled with the copper body, the reinforcement body having a reinforcement alloy being configured to minimize thermal-expansion stress being induced between the copper alloy and the reinforcement alloy, a thermal expansion coefficient of the reinforcement alloy is substantially similar to the thermal expansion coefficient of the copper alloy.

18. A hot-runner nozzle assembly, comprising:
a copper body having a copper alloy; and
a reinforcement body being coupled with the copper body, the reinforcement body having a reinforcement alloy being configured to minimize thermal-expansion stress being induced between the copper alloy and the reinforcement alloy, the copper alloy and the reinforcement alloy have a range of thermal expansion from between about 14×10⁻⁶ and about 18×10⁻⁶ meter per meter per degree Centigrade.

19. A hot-runner nozzle assembly, comprising:
a copper body having a copper alloy;
a reinforcement body being coupled with the copper body, the reinforcement body having a reinforcement alloy being configured to minimize thermal-expansion stress being induced between the copper alloy and the reinforcement alloy; and
a second reinforcement body, and the copper body is positioned between the second reinforcement body and the reinforcement body, the second reinforcement body being coupled with the copper body, the second reinforcement body having a second reinforcement alloy being configured to minimize thermal-expansion stress being induced between the copper alloy and the second reinforcement alloy.

20. A hot runner having the hot-runner nozzle assembly of claim 1.

21. An injection-molding system including a hot runner having the hot-runner nozzle assembly of claim 1.
